(19) United States
(12) Patent Application Publication
(10) Pub. No.: US 2008/0304526 A1
(43) Pub. Date: Dec. 11, 2008

(54) GREEN LASER OPTICAL PACKAGE

(76) Inventors: Sung-Soo Park, Suwon-si (KR); Du-Chang Heo, Suwon-si (KR); Mun-Kue Park, Suwon-si (KR)

Correspondence Address: CHA & REITER, LLC, 210 ROUTE 4 EAST STE 103, PARAMUS, NJ, 07652, US

(21) Appl. No.: 12/112,019

(22) Filed: Apr. 30, 2008

(30) Foreign Application Priority Data
Jun. 7, 2007 (KR) 55513/2007

(51) Int. Cl. H01S 3/04

(52) U.S. Cl. 372/36

(57) ABSTRACT

A green laser optical package includes a laser light source generating light of an infrared wavelength band, a harmonic wave generator converting an infrared light output from the laser light source into a second harmonic wave so as to output the converted second harmonic wave, and at least one support member attached to side surfaces of the laser light source and the harmonic wave generator.

### CLAIM OF PRIORITY

This application claims the benefit of the earlier filing date, under 35 U.S.C. §119(a), to that patent application entitled “Green Laser Optical Package” filed in the Korean Intellectual Property Office on Jun. 7, 2007 and assigned Serial No. 2007-0055513, the contents of which are hereby incorporated by reference.

### BACKGROUND OF THE INVENTION

1. Field of the Invention

The present invention relates to a green laser optical package, and more particularly to a green laser optical package including a harmonic wave generator.

2. Description of the Related Art

A laser light source generates light having a narrow line width and a high energy characteristic so that it has been applied to various fields, such as a performance illumination, a distance measuring instrument, and an image means, for example. The laser light source serving as the image means can be employed in a laser image scan device or the like using laser light of three primary colors, i.e. red, blue, and green color.

The above described image scan device includes a scan optical system and a drum used for a laser printer or the like, and a laser image projector for projecting the laser light sources onto a screen for displaying an image.

The green laser light source has required a configuration in which an infrared light is wavelength converted into a second harmonic wave (green light). The configuration includes a solid laser generating an infrared light, a pumping light source for pumping the solid laser, and a harmonic wave generator for wavelength converting the generated infrared light into the second harmonic wave so as to output a green light.

Due to a high heat emission characteristic of the laser light sources, when the laser light sources are used for many hours, the output line width and wavelength of the light are changed so that it creates a problem of decreasing the optical coherence characteristic. Therefore, the green laser optical package additionally requires a thermoelectric cooling element in order to maintain the heat emission characteristic.

The conventional green laser optical package described above has a structure in which attaching elements for the wavelength conversion, such as the solid laser and the harmonic wave generator are assembled on the thermoelectric cooling element with an adhesive or the like. However, in conventional green laser optical package, due to non-uniform pressure applied to the attaching surface, the output laser light has inconstant characteristics (i.e. line width, wavelength, etc). Specifically, when a completed green laser optical package assembled with the thermoelectric cooling element or the like has a defect, assembling loss may increase due to process delay and discarded elements.

### SUMMARY OF THE INVENTION

In accordance with an aspect of the present invention, there is provided a green laser optical package that includes a laser light source generating light in an infrared wavelength band, a harmonic wave generator converting the infrared light output from the laser light source into a second harmonic wave and outputting the converted second harmonic wave and at least one support member attached to side surfaces of the laser light source and the harmonic wave generator.

### BRIEF DESCRIPTION OF THE DRAWINGS

The above and other aspects, features and advantages of the present invention will be made apparent from the following detailed description taken in conjunction with the accompanying drawings, in which:

FIG. 1 is a perspective view illustrating a green laser optical package according to a first embodiment of the present invention;

FIG. 2 is a diagram of the green laser optical package of FIG. 1 taken along the A-A′ line;

FIG. 3 is a diagram of the green laser optical package of FIG. 1 taken along the B-B′ line;

FIG. 4 is a diagram illustrating a green laser optical package according to a second embodiment of the present invention;

FIG. 5 is a diagram illustrating a green laser optical package according to a third embodiment of the present invention;

FIG. 6 is a diagram illustrating a green laser optical package according to a fourth embodiment of the present invention; and

FIG. 7 is a cross-sectional view illustrating a green laser light source according to a fifth embodiment of the present invention.

### DETAILED DESCRIPTION THE INVENTION

Exemplary embodiments of the present invention will be described with reference to the accompanying drawings. For the purposes of clarity and simplicity, a detailed description of known functions and configurations incorporated herein will be omitted as it may make the subject matter of the present invention unclear.

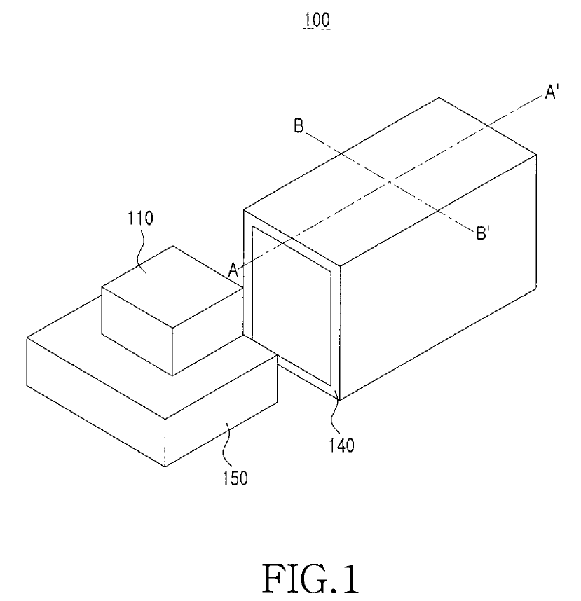

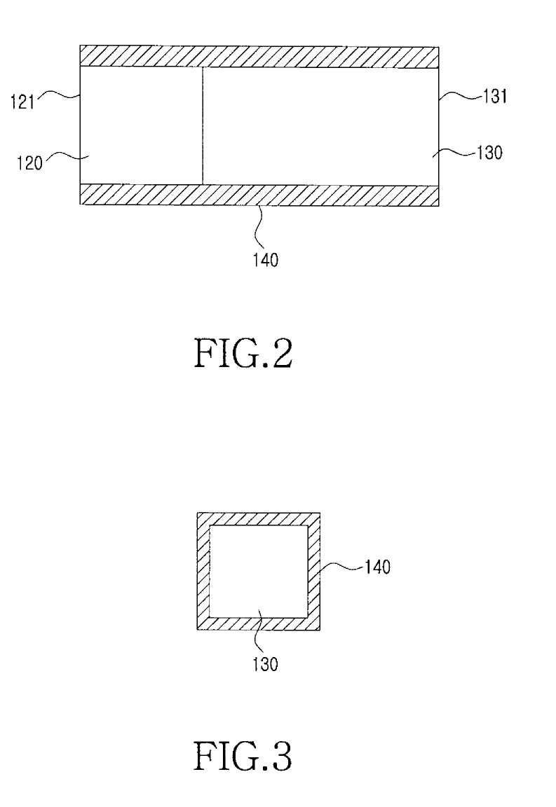

FIG. 1 is a perspective view illustrating a green laser optical package according to a first embodiment of the present invention, FIG. 2 is a cross-sectional view of the green laser optical package of FIG. 1 taken along the A-A′ line, and FIG. 3 is a cross-sectional view of the green laser optical package of FIG. 1 taken along the B-B′ line. Referring to FIGS. 1 to 3, the green laser optical package 100 according to the present invention includes a laser light source 120 for generating light of an infrared wavelength band, a harmonic wave generator 130 for converting the infrared light output from the laser light source 120 into a second harmonic wave so as to output the converted second harmonic wave, at least one support member 140 attached to side surfaces of the laser light source 120 and the harmonic wave generator 130, a pumping light source 110 for outputting a pumping light to one surface 121 of the laser light source 120, and a sub-mount 150 for supporting the pumping light source 110.

One surface of the laser light source 120 through which the laser light is output—is positioned to be in contact with a surface of the harmonic wave generator 130, and the support member 140 is attached to surrounding side surfaces, rather than a surface 131 through which the laser light source 120 and the second harmonic wave (light of a green wavelength) of the harmonic wave generator 130 are output. The support member 140 may be made of silicon, which has a thermal conductivity similar with that of the laser light source 120 and the harmonic wave generator 130.

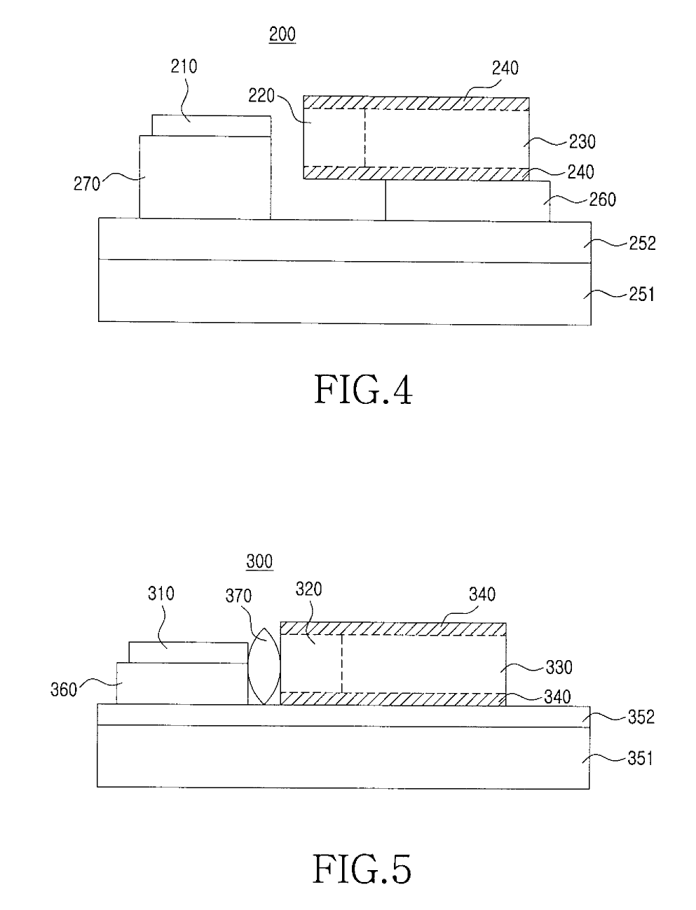

FIG. 4 is a diagram illustrating a green laser optical package according to a second embodiment of the present invention. Referring to FIG. 4, the green laser optical package 200 according to the second embodiment of the present invention includes a laser light source 220 for generating light of an infrared wavelength band, a harmonic wave generator 230 for converting an infrared light output from the laser light source 220 into a second harmonic wave (i.e., light of a green wavelength) so as to output the converted second harmonic wave, at least one support member 240 attached to side surfaces of the laser light source 220 and harmonic wave generator 230, a pumping light source 210 for pumping the laser light source 220, a first sub-mount 260 and a second sub-mount 270, a thermal conduction block 252, and a thermoelectric cooling element 251.

The thermal conduction block 252 is positioned between the first sub-mount 260 and the second sub-mount 270, and the thermoelectric cooling element 251, and may he made of metals having a superior thermal conductivity, e.g., copper (Cu) or silver (Ag).

The thermoelectric cooling element 251 functions to maintain a substantially uniform thermal characteristic of the pumping light source 210, the laser light source 220, and the harmonic wave generator 230.

The first sub-mount 260 is fixed under the harmonic wave generator 240 and on an upper surface of the thermal conduction block 252 so as to support the harmonic wave generator 230 and the laser light source 220. The first sub-mount 260 is inserted between a part of the harmonic wave generator 240 and the thermal conduction block 252 in order to form a space between the laser light source 220 and the thermal conduction block 252 so that it can prevent the adhesive, such as an epoxy, used for assembly from being introduced into a path of light.

The support member 240 has a shape of a bar made of a silicon material and encloses the harmonic wave generator 230 and the laser light source 220, and is in contact with side surfaces of the laser light source 220 and the harmonic wave generator 230.

FIG. 5 is a diagram illustrating a green laser optical package according to a third embodiment of the present invention. Referring to FIG. 5, the green laser optical package 300 according to the third embodiment of the present invention includes a laser light source 320 for generating light of an infrared wavelength band, a harmonic wave generator 330 for converting an infrared light output from the laser light source 320 into a second harmonic wave and outputting the converted second harmonic wave, at least one support member 340 attached to side surfaces of the laser light source 320 and the harmonic wave generator 330, a pumping light source 310 for pumping the laser light source 320, a thermal conduction block 352, a thermoelectric cooling element 351, a sub-mount 360, and a lens 370 interposed between the pumping light source 310 and the laser light source 320.

The support member 340 is attached to the side surfaces of the laser light source 320 and the harmonic wave generator 330 and is contact with an upper surface of the thermal conduction block 352. The support member 340 may be made of a silicon material.

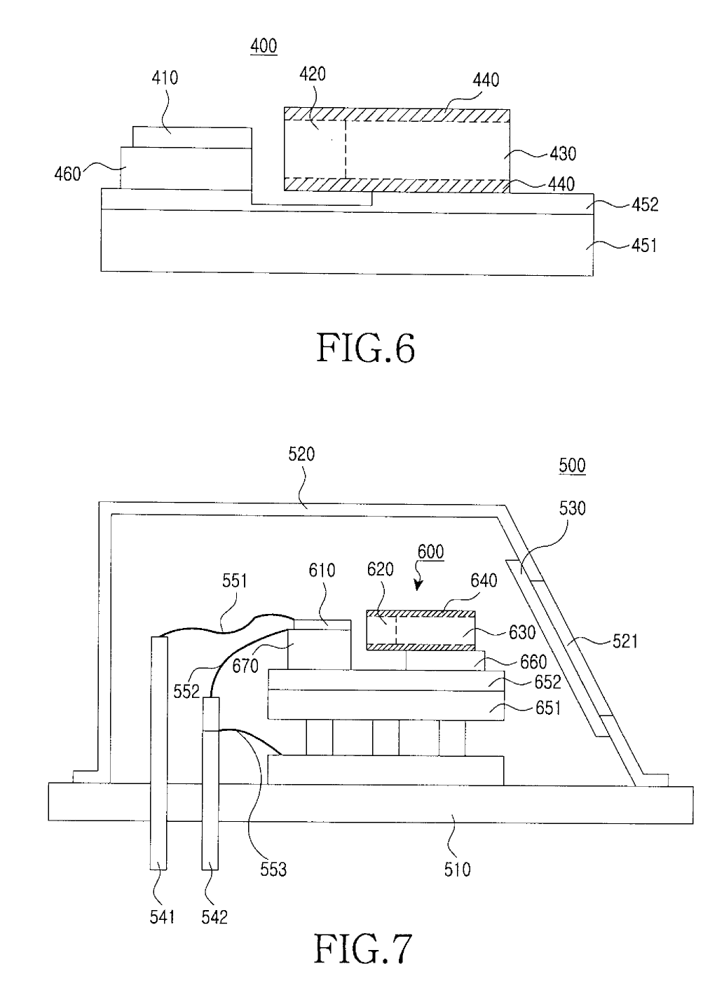

FIG. 6 is a diagram illustrating a green laser optical package according to a fourth embodiment of the present invention. Referring to FIG. 6, a green laser optical package 400 according to the fourth embodiment of the present invention includes a laser light source 420 for generating light of in infrared wavelength band, a harmonic wave generator 430 for converting an infrared light output from the laser light source 420 into a second harmonic wave and outputting the converted second harmonic wave, at least one support member 440 attached to side surfaces of the laser light source 420 and the harmonic wave generator 430, a pumping light source 410 for pumping the laser light source, a thermal conduction block 452, a thermoelectric cooling element 451, and a sub-mount 460.

The pumping light source is fixed on the sub-mount 460, and the sub-mount 460 is fixed on the thermal conduction block 452.

The support member 440 is attached to side surfaces of the laser light source 420 and the harmonic wave generator 430, which are not the surfaces through which light is incident and output. The laser light source 420 and the harmonic wave generator 430 can be assembled on the thermal conduction block 452 through the support member 440.

The thermal conduction block 452 is attached on an upper surface of the thermoelectric cooling element 451, and may be made of a metal material. The thermal conduction block 452 has a groove at a position corresponding to the laser light source 420 so as to prevent an adhesive, such as an epoxy, glue, and other knows in the artisians, existing between the support member 440 and the thermal conduction block 452, from being filled in the space between the pumping light source 410 and the laser light source 420.

FIG. 7 is a cross-sectional view illustrating a green laser light source according to a fifth embodiment of the present invention. Referring to FIG. 7, the green laser light source 500 according to the fifth embodiment of the present invention has a structure of TO-Can, which includes a stem 510, a green laser optical package 600 fixed on an upper surface of the stem 510, and a housing 520 disposed on the upper surface of the stem 510 in order to cover the green laser optical package 600.

The housing 520 includes an opening 521 at a side surface thereof, and a window 530 can be attached on the opening 521.

A plurality of leads 541 and 542 passes through the stem 510, and the respective leads 541 and 542 are connected to the green optical package 600 by means of wires 551, 552, and 553 so as to provide electricity and a control signal.

The green optical package 600 includes a pumping light source 610, a laser light source 620, a harmonic wave generator 630, a support member 640, a first sub-mount 660 and a second sub-mount 670, a thermoelectric cooling element 651, and a thermal conduction block 652, and has a structure substantially identical to that of the green optical package according to the first embodiment of the present invention.

The green laser light source according to the fifth embodiment of the present invention can be employed in a structure that one of the embodiments of a green laser optical package shown herein is mounted inside of the housing 520.

According to the present invention, the support member is attached to the side surfaces of the laser light source and the harmonic wave for generator generating a green laser light, so that the faultiness due to a non-uniform assembly characteristic occurring when the laser light source and the harmonic wave generator are mounted on the thermal conduction block or the sub-mount, can be minimized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A green laser optical package comprising:
a pump light source,
a laser light source generating light of an infrared wavelength band receiving a light from said pump light source;
a harmonic wave generator, in contact with the light source, converting an infrared light output from the laser light source into a second harmonic wave and outputting the converted second harmonic wave;
at least one support member attached to side surfaces of the laser light source and the harmonic wave generator;
a thermal conduction block positioned on a lower surface of the laser light source, the harmonic wave generator, and the pumping light source; and
a thermoelectric cooling element positioned on a lower surface of the thermal conduction block,

2. The green laser optical package as claimed in claim 1, further comprising:
a first sub-mount interposed between the harmonic wave generator and the thermal conduction block; and
a second sub-mount interposed between the pumping light source and the thermal conduction block.

3. The green laser optical package as claimed in claim 2, further comprising:
a stem on which the thermoelectric cooling element is positioned; and
a plurality of leads passing through the stem, the plurality of the leads electrically connected to the pumping light source, the laser light source, and the harmonic wave generator.

4. The green laser optical package as claimed in claim 3, further comprising:
a housing positioned on an upper surface of the stem in order to cover the pumping light source, the laser light source, and the harmonic wave generator, the housing having an opening facing an output surface of the harmonic wave generator.

5. The green laser optical package as claimed in claim 1, wherein the thermal conduction block has a groove at a position corresponding to the laser light source.

6. The green laser optical package as claimed in claim 1, wherein the support member is attached to side surfaces of the harmonic wave generator and the laser light source rather than one surface of the laser light source through which the pumping light is incident and another surface through which a second harmonic wave of the harmonic wave generator is output.

7. The green laser optical package as claimed in claim 6, wherein the support member is made of a silicon material.

8. The green laser optical package as claimed in claim 1, further comprising:
a lens interposed between the pumping light source and the laser light source.

9. The green laser optical package as claimed in claim 1, further comprising:
a sub-mount interposed between the pumping light source and the thermal conduction block.

10. A green laser optical package comprising:
a stem;
a housing attached to said substrate, said housing including at least one surface partially including a transparent surface;
a laser package contained within said housing, comprising:
a harmonic wave generator, in contact with the light source, converting an infrared light into a second harmonic wave and outputting the converted second harmonic wave through said transparent surface;
a laser light source generating said infrared light;
a first thermal conduction block positioned on a lower surface of the harmonic wave generator; and
a thermoelectric cooling element positioned on a lower surface of the first thermal conduction block, said cooling element attached to said stem.

11. The package as recited in claim 10, further comprising:
a second thermal conduction block positioned between a lower surface of the laser light source and an upper surface of said thermoelectric cooling element.

12. The package as recited in claim 10, further comprising:
a pump laser providing as light source to said laser source.

13. The package as recited in claim 12, further comprising:
a third thermal conduction block positioned between a lower surface of the laser light source and an upper surface of said thermoelectric cooling element.

14. The package as recited in claim 11, wherein said first and second thermal conduction blocks are a single unit.

15. The package as recited in claim 13, wherein said third thermal conduction block aligns said pump laser with said laser light source.

16. The package as recited in claim 13, wherein said first, second and third thermal conduction blocks are a single unit.

17. The package as recited in claim 10, further comprising:
at least one support member attached to side surfaces of the laser light source and the harmonic wave generator.

18. The package as recited in claim 10, further comprising:
a pair of leads extending through said stem providing electrical and control signals.

19. The package as recited in claim 12, further comprising:
a lens positioned between said pump laser and said laser light source.

20. The package as recited in claim 12, further comprising:
a sub-mount positioned between selected ones of the thermal conduction block and associated pump laser, laser light source, or harmonic generator.
